(19) United States
(12) Patent Application Publication
(10) Pub. No.: US 2006/0172123 A1
(43) Pub. Date: Aug. 3, 2006

(54) Thin film patterning arrangement

(76) Inventors: Paulus Cornelis Duineveld, Drachten (NL); Peter Jan Slikkerveer, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/564,298

(22) PCT Filed: Jul. 8, 2004
(86) PCT No.: PCT/IB04/51170

§ 371 Date: Jan. 10, 2006

(30) Foreign Application Priority Data
Jul. 18, 2003 (EP) 03102227.0

(51) Int. Cl. B41M 5/00

(52) U.S. Cl. 428/195.1

(57) ABSTRACT

A thin film patterning arrangement (6), comprising a substrate (1) and barriers (3) arranged to partition a surface of the substrate (1) into sub-areas (5) is disclosed. Said surface is of a polymeric material, and is coated with an at least partly inorganic coating (2). Thin film material (4) is preferably deposited on said thin film patterning arrangement (6).

The present invention relates to a thin film patterning arrangement, comprising a substrate and barriers arranged to partition a surface of the substrate into sub-areas. It also relates to methods for the manufacture of such thin film patterning arrangements as well as to devices comprising such thin film patterning arrangements.

Technologies for obtaining functional devices by forming predefined patterns of thin films having different properties on the same substrate have been under development during recent years. Among such functional devices are colour filters and thin film electronics such as display devices and conductor/semiconductor patterns.

One promising method for the formation of such patterns uses ink jet printing of liquids comprising the thin film materials. Ink jet printing is a preferred method due to its low material usage, high precision and relatively low cost. However, one problem with ink jet printing of the patterns is that different thin film materials may become mixed on the surface of the substrate. For example, when using ink jet printing for forming a thin film pattern such as a colour filter for a LCD-device, the liquid material that is discharged may flow into adjacent pixels, resulting in pixels with mixed colours.

To prevent this, the surface of the substrate is usually provided with protruding partitioning members, called barriers. The barriers partition the surface into sub-areas which define the thin film patterns. The liquids comprising the thin film materials are then deposited on the different sub-areas. For the example with the LCD colour filter, the substrate surface is partitioned into pixels, each pixel in turn being partitioned into sub-pixels for the different colours (usually red, green and blue). Each sub-pixel is then filled with its coloured thin film material without any mixing of the colours. The partitioning barriers are generally photoresists of organic material, the patterns of which typically have been defined by lithography.

Usually, a requirement for the functional devices is that they are thin. This puts limitations on the height of the protruding barriers, and therefore also on the volumes of the deposited liquid material for each partitioned area. If a too large volume of liquid is deposited, it will readily flow over to an adjacent partitioned area. In contrast, if a too small volume of liquid is deposited, it will not coat the entire surface of the partitioned area, resulting in irregular patterning and bad or even non-functional devices.

Typically, for the case with an inorganic substrate, such as glass, provided with organic barriers, a surface treatment is performed to establish a difference in surface energy between the surface of the substrate (where the droplets from the ink jet printing lands) and the barriers. This is to maintain a relatively high liquid wetting, i.e. low surface-liquid advancing contact angle, on the substrate surface, and to obtain a relatively low liquid wetting, i.e. high surface-liquid advancing contact angle, on the partitioning barriers. After the surface treatment, the liquid will wet the substrate surface while not wetting the barriers, thus preventing the liquid to flow over to an adjacent partitioned area

The surface treatment is described in detail in EP 0 989 788, and is typically as follows: first the substrate is cleaned by e.g. oxygen plasma or UV ozone treatment. Then a fluor plasma like CF₄, CHF₃ or SF₆ is applied. The fluor moieties adhere to the organic barrier material, thus making the barriers repellent to the printed liquid, while leaving the wetting of the inorganic substrate material essentially unaffected. Thus a contrast in surface energy between the barriers and the substrate surface is established, and a relatively large volume of the liquid comprising the thin film material may be deposited on the partitioned area without overflowing the barriers.

In EP 0 989 788, inorganic substrates for patterning thin films are described. However, there is a demand for functional devices, such as electronic, optical and opto-electronic devices, that are based on polymeric substrates rather than inorganic substrates, such as glass substrates. This is the case in for example thin, light and/or flexible functional devices. Organic partitioning barriers, such as photoresists, are readily arranged on plastic surfaces using lithography with good reproducibility and tolerances.

However, since there is no distinct difference in material properties between the substrate and the barriers, both the barriers and the substrate will be affected in the same way when performing a surface treatment as described above, and no difference in liquid affinity between the barriers and the substrate will be established. After the previously described two step surface treatment the contact angle on the organic surface substrate will, due to the fluor plasma, also be relatively high, resulting in a problem to cover the partioned areas with liquid. On the other hand, after only a first cleaning treatment, e g oxygen plasma or UV-ozone, the organic coating as well as the barriers will have a relatively low contact angle with the printed liquid which will make it difficult for the ink jet printed drops to cover the partitioned areas without overflowing the barriers and become mixed with the thin film material deposited in adjacent partitioned areas.

One object of the present invention is to alleviate the above mentioned problems related to the use of polymeric substrates, and to provide functional thin film devices based on polymeric substrates.

These and other objects are obtained by the present invention.

The present invention relates to a thin film patterning arrangement, comprising a substrate and barriers arranged to partition a surface of the substrate into sub-areas. Said surface is of polymeric material, and is at least partly coated with an at least partly inorganic coating. The coating may be completely or partly inorganic, and may in some embodiments comprise more than one coating material, i.e. a non-homogenous coating.

The at least partly inorganic coating preferably possesses such properties, that after the thin film patterning arrangement is subjected to a surface treatment, a difference in liquid affinity is established so that the barrier affinity of the liquid is less than the substrate affinity of the liquid.

Thereby, it is possible to provide an organic thin film patterning arrangement with different wetting properties along its surface.

The present invention also relates to a method for the manufacture of a thin film patterning arrangement, comprising supplying a substrate with a surface of organic material, coating at least part of the surface of said substrate with an at least partly inorganic coating, and depositing barriers to partition said coated surface into sub-areas. The method preferably also comprises a surface treatment, whereby a liquid affinity difference between the coated surface and the barriers is established.

In addition, the present invention relates to devices comprising thin film patterning arrangements with thin film patterns deposited on said substrates. It also relates to methods for the manufacture of said devices comprising deposition of thin film material on said thin film patterning arrangements.

These and other aspects of the invention will be apparent from and elucidated with reference to the embodiments described hereafter.

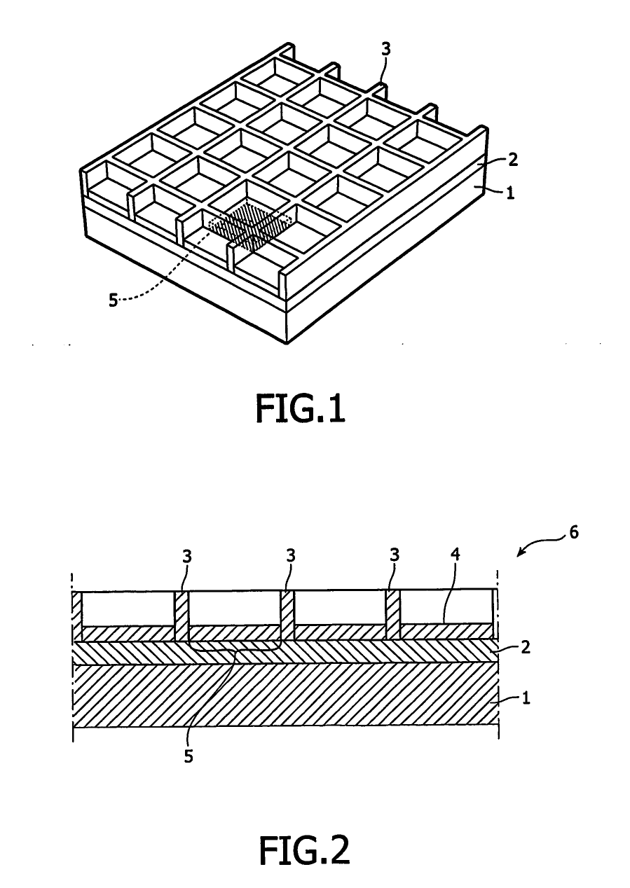

FIG. 1 illustrates a perspective view of a thin film patterning arrangement.

FIG. 2 illustrates a sectional view of the arrangement of FIG. 1.

FIGS. 1 and 2 shows a thin film patterning arrangement 6 comprising a polymeric substrate 1, coated with an at least partly inorganic coating 2 and arranged with partitioning barriers 3. A thin film material 4 is deposited on the partitioned sub-areas 5.

The polymeric substrate 1, or at least a surface of said substrate (1), may be of any polymeric material suitable for use as a substrate, such as, but not limited to, polycarbonate (PC), polyethersulfon (PES), polynorbonene (PNB), polyarylate (PAR), polyethylentheraftalate (PET), polyethernafthalate (PEN), epoxide, polymethylmethacrylate (PMMA), polyurethane (PUR). Different materials may be suited for different uses and are known to the man skilled in the art. The substrate may be of an organic compound, or an at least partly inorganic compound arranged with a organic surface.

The at least partly inorganic coating 2 may comprise any inorganic material, including non-conducting materials suitable for deposition using sputtering or vapour deposition, like silicon nitride, aluminium nitride, silicon oxide, silicon oxynitride, silicon oxide fluoride, titanium oxide, zirconium oxide, hafnium oxide, aluminium oxide or mixtures thereof. The at least partly inorganic coating 2 may also comprise conducting materials like ITO (indium oxide doped with tin oxide). The inorganic materials could be incorporated as (nano) particles inside a partly organic coating resin, or could be part the chemical structure of the coating material itself (such as an ORMOCER). Also inorganic materials suitable for wet chemical deposition, e g spin coating, such as TEOS (tetraethyloxysilane) may be used.

The at least partly inorganic coating 2 preferably comprises at least 5% (w/w), more preferred at least 25%, even more preferred at least 45% inorganic material. It may even comprise 100% inorganic material. For example, a coating comprising 20% C atoms, 38% O atoms and 42% Si atoms may be used. One advantage with using partly inorganic coatings is that such coatings are more often suitable for wet coating methods, such as inkjet printing and spin coating, than are 100% inorganic coatings. 100% inorganic coatings more often need to be deposited on the substrate with such methods as vacuum deposition. The at least partly inorganic coating 2 may be deposited on the substrate 1 using any suitable deposition method, including sputtering, vapour deposition, spin coating, screen printing, vacuum deposition and spray coating. The most suitable deposition methods and conditions for these varies with the coating and substrate materials of choice and are known to the man skilled in the art. For some applications, such as display devices and colour filters, the at least partly inorganic coating 2 is preferably transparent, while for other applications, this is not necessary. The thickness of the at least partly inorganic coating 2 may be from less than 0.01 μm to more than 100 μm. The at least partly inorganic coating 2 may be non-homogenous, i.e. comprise more than one coating materials. Non-limiting examples of such non-homogenous coatings are used in arrangements wherein different coatings are used for different sub-areas, two coatings are deposited on top of each other, etc.

The barrier 3 may be any conventional organic photoresists, such as e.g. AZ5218-e (AZ Hoechst), standard SU-8 photoresist (MicroChem Corp) or photo patternable organic polyimide. The barriers 3 may be applied on the coated substrate by different suitable methods, including photo-lithography technique, gravure-offset printing, ink jet printing, screen printing, micro contact printing, Micro Moulding In Capillaries (MIMIC) or waterless offset printing. The most suitable application methods and conditions for these varies with the barrier material of choice and are known to a man skilled in the art.

In the present invention, it is desirable that the surface of the at least inorganic coating 2 in the partitioned sub-areas and the surfaces of the barriers 3 are subjected to a surface treatment so that the barriers 3 exhibit a higher degree of non-affinity for a liquid comprising thin film material 4 intended to be deposited on the thin film patterning arrangement, than the sub-areas where the thin film material 4 is intended to be deposited. By performing this treatment so that the liquid contacting angle for the barriers are large enough (e g >40°) (low wetting) and the liquid contacting angle for the sub-areas are small enough (e g <25°) (high wetting), the liquid will not exceed and overflow the barriers even if the liquid volume is relatively large, and the thin film will hence only be deposited in the predetermined sub-areas. The combination of materials for the barriers and the coating are preferably chosen so that this difference in liquid affinity can be established.

The surface treatment may be performed using plasma treatment with a gas containing fluorine or fluorine based compounds as induction gas. Example of such fluorine based gasses preferably comprises CF₄, SF₆, CHF₃ or combinations thereof As a result of this surface treatment, the fluorine compounds will adhere to the organic barriers, but not to an as large extent to the substrate coating, thus establishing the desired difference in liquid affinity between the barriers and the substrate coating. It has been found that the at least partly inorganic coating does not need to be totally intact to function properly. Small cracks or cavities, e.g. such that could appear in post-deposition processing of the arrangement, does not adversely affect the wetting properties to any essential extent. Other surface treatment methods which results in similar liquid affinity difference between the barriers and the coating may also be used.

The present invention also relates to a device comprising a thin film patterning arrangement as described above whereon a patterned thin film is deposited. The deposited thin film material may, among others, be colouring materials, non-conducting materials, conducting materials, semi-conducting materials or combinations thereof, and the devices may, among others, consequently be colour filters for various applications including display devices such as LCD's, different types of thin film electronic devices such as active matrix arrays for display devices, smart tags and smartcards.

The thin film material may be deposited on the thin film patterning surface using different methods, including droplet-on-demand piezoelectric ink-jet printing, bubble jet printing, continuous ink-jet printing, flexographic printing, screen printing etc. The deposition step is usually followed by an evaporation step, wherein the solvents in the deposited liquid is evaporated, leaving the solid thin film material on the surface of the coating.

The present invention should not be considered as being limited to the above described embodiments and the following experiments. It includes all possible variations covered by the scope defined by the appended claims.

Experiments

Partly Inorganic Coating Layer

A polycarbonate sheet was coated with a coating comprising 20% C atoms, 38% O atoms and 42% Si atoms. Conventional HPR photoresist barriers were applied on the coated plastic sheet to form a thin film patterning arrangement for use as a colour filter according to the invention. The barriers (50 μm wide) were arranged to form 800×800 μm pixels, each divided into three sub-pixels 800×217 μm in size (inner dimensions). The substrate were subjected to cleaning with oxygen plasma and subsequent surface treatment with CF₄ plasma. After treatment, red, green and blue colour inks with viscosity of 12 cP were deposited in the sub-pixels using a MicroDrop GmbH single-nozzle ink-jet head with a nozzle diameter of 50 micron. One droplet of ink (diameter −55 μm) was printed each 65 μm to fill the sub-pixels with colour ink. The advancing contact angle of the ink was measured and it was found to be 10-20° on the partly inorganic coating, while >50° on the organic barriers.

Thus it was found that it was possible to establish the desired difference in liquid affinity between the barriers and a polymeric substrate coated with a partly inorganic coating.

Inorganic Coating Layer

An ITO (indium-tin oxide) coating was deposited on top of a polycarbonate sheet using vacuum deposition technique. On this substrate same type of barriers were arranged and ink droplets were printed as in the foregoing experiment. The results were also substantially identical to those of the foregoing experiment.

Thus it was found that it was possible to establish the desired difference in liquid affinity between the barriers and a polymeric substrate coated with an inorganic coating.

A thin film patterning arrangement (6), comprising a substrate (1) and barriers (3) arranged to partition a surface of the substrate (1) into sub-areas (5) is disclosed. Said surface is of a polymeric material, and is coated with an at least partly inorganic coating (2). Thin film material (4) is preferably deposited on said thin film patterning arrangement (6).

1. A thin film patterning arrangement, comprising a substrate and barriers arranged to partition a surface of the substrate into sub-areas characterised in that at least said surface is of polymeric material, and said surface is at least partly coated with at an least partly inorganic coating.

2. An arrangement according to claim 1, wherein said at least partly inorganic coating comprises 100% inorganic material.

3. An arrangement according to claim 1, wherein said at least partly inorganic coating comprises at least 5% inorganic material.

4. An arrangement according to claim 1, wherein said at least partly inorganic coating comprises at least two separate coating materials.

5. An arrangement according to claim 1, wherein after a surface treatment, a difference in advancing contact angle of at least 10 degrees between the surface of said at least partly inorganic coating and the surfaces of said barriers is established.

6. An arrangement according to claim 1, wherein said at least partly inorganic coating is more than 70% transparent.

7. A method for producing a thin film patterning arrangement, comprising:
supplying a substrate with at least a surface of polymeric material,
coating at least a part of said surface of said substrate with an at least partly inorganic coating, and
depositing barriers on said at least one coated surface.

8. A method according to claim 7, further comprising:
subjecting said at least partly inorganic coating and said barriers to a surface treatment.

9. A method according to claim 8, wherein said surface treatment comprises plasma treatment.

10. A thin film device comprising a thin film patterning arrangement (6) according to claim 1, or a thin film patterning arrangement obtainable by the method according to claim 7, further comprising thin film material deposited on at least part of said sub-areas.

11. A thin film device according to claim 10, wherein said thin film material forms at least one thin film pattern selected from the group comprising optical patterns, conductor patterns, insulator patterns, semiconductor patterns and combinations thereof.

12. A thin film device according to claim 11, wherein said thin film pattern is an optical pattern and said device is a colour filter.

13. A method for manufacture of a thin film device, comprising:
providing a thin film patterning arrangement according to the claim 1, or a thin film patterning arrangement obtainable by a method according to claim 7, and
depositing at least one thin film material on at least part of said sub-areas.

14. A method according to claim 12 wherein said depositing of thin film material comprises:
ink jet printing of a liquid comprising said thin film material.

15. A display device comprising a thin film patterning arrangement according to claim 1 a thin film patterning arrangement obtainable by a method according to claim 7, a thin film device according to claim 10, or a thin film device obtainable by a method according to claim 13.
